(19) United States
(12) Patent Application Publication
(10) Pub. No.: US 2014/0355189 A1
(43) Pub. Date: Dec. 4, 2014

(54) Electronic Device and Input Control Method

(71) Applicant: Kabushiki Kaisha Toshiba, Tokyo (JP)

(72) Inventor: Masanori Nakano, Koganei-shi (JP)

(73) Assignee: Kabushiki Kaisha Toshiba, Tokyo (JP)

(21) Appl. No.: 14/243,664

(22) Filed: Apr. 2, 2014

(30) Foreign Application Priority Data
May 31, 2013 (JP) 2013-116347

(51) Int. Cl. G06F 1/16

(52) U.S. Cl. CPC G06F 1/1662
USPC 361/679.11

(57) ABSTRACT

According to one embodiment, an electronic apparatus includes a first housing, a second housing, a first controller and a second controller. The first housing includes a top surface on which a hardware keyboard is disposed. The second housing includes a front surface on which a display is disposed and is set in a first position or a second position. The first controller enables the hardware keyboard when the second housing is set in the first position and disables the hardware keyboard when the second housing is set in the second position. The second controller disables a software keyboard displayed on the screen when the second housing is set in the first position, and enables the software keyboard when the second housing is set in the second position.

### CROSS-REFERENCE TO RELATED APPLICATIONS

This application is based upon and claims the benefit of priority from Japanese Patent Application No. 2013-116347, filed May 31, 2013, the entire contents of which are incorporated herein by reference.

### FIELD

Embodiments described herein relate generally to an electronic apparatus which is capable of executing a keyboard input, and an input control method applied to the electronic apparatus.

### BACKGROUND

In recent years, with the progress in diversification of personal computers, there has been developed a convertible-type computer, which can take forms that are adaptive to both a notebook-type (laptop-type) personal computer, and a tablet-type computer. The convertible-type computer can alter its style between two styles (two modes), namely a notebook mode and a tablet mode.

The convertible-type computer includes, for example, a housing on which a touch-screen display is provided, and a housing on which a hardware keyboard is provided. By changing the arrangement between the two housings, the convertible-type computer can be used in either the notebook mode or the tablet mode.

In this convertible-type computer, there is a possibility that an erroneous operation is input, because a user unintentionally presses a key on the hardware keyboard due to a displacement of the two housings, or because a user unintentionally touches the hardware keyboard or touch-screen display when the arrangement between the two housings is altered.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating external appearances of an electronic apparatus according to an embodiment, which correspond to a portable mode, a laptop mode and a tablet mode.

FIG. 2 is an exemplary view for describing a relationship between a base unit and a display unit which are provided in the electronic apparatus of the embodiment.

FIG. 3 is an exemplary block diagram illustrating a system configuration of the electronic apparatus of the embodiment.

FIG. 4 is an exemplary block diagram illustrating a functional configuration of a key input control program executed by the electronic apparatus of the embodiment.

FIG. 5 is a view for explaining an example in which a hardware keyboard and a software keyboard are controlled based on modes by the electronic apparatus of the embodiment.

FIG. 6 is a flowchart illustrating an example of the procedure of a transition process to a laptop mode, which is executed by the electronic apparatus of the embodiment.

FIG. 7 is a flowchart illustrating an example of the procedure of a transition process to a tablet mode, which is executed by the electronic apparatus of the embodiment.

FIG. 8 is a flowchart illustrating an example of the procedure of a transition process to a portable mode, which is executed by the electronic apparatus of the embodiment.

FIG. 9 is a perspective view for describing another example of external appearances of the electronic apparatus of the embodiment.

FIG. 10 is an exemplary view for describing a relationship between a base unit and a display unit which are provided in the electronic apparatus shown in FIG. 9.

### DETAILED DESCRIPTION

Various embodiments will be described hereinafter with reference to the accompanying drawings.

In general, according to one embodiment, an electronic apparatus includes a first housing, a second housing, a first controller, and a second controller. The first housing includes a top surface on which a hardware keyboard is disposed. The second housing includes a front surface on which a display is disposed. The second housing is set in either a first position where a screen of the display and the top surface are exposed, or a second position where the screen of the display is exposed and at least a part of the top surface is covered with a back surface of the second housing. The first controller is configured to enable an operation on the hardware keyboard when the second housing is set in the first position, and to disable the operation on the hardware keyboard when the second housing is set in the second position. The second controller is configured to disable an operation on a software keyboard displayed on the screen when the second housing is set in the first position, and to enable the operation on the software keyboard when the second housing is set in the second position.

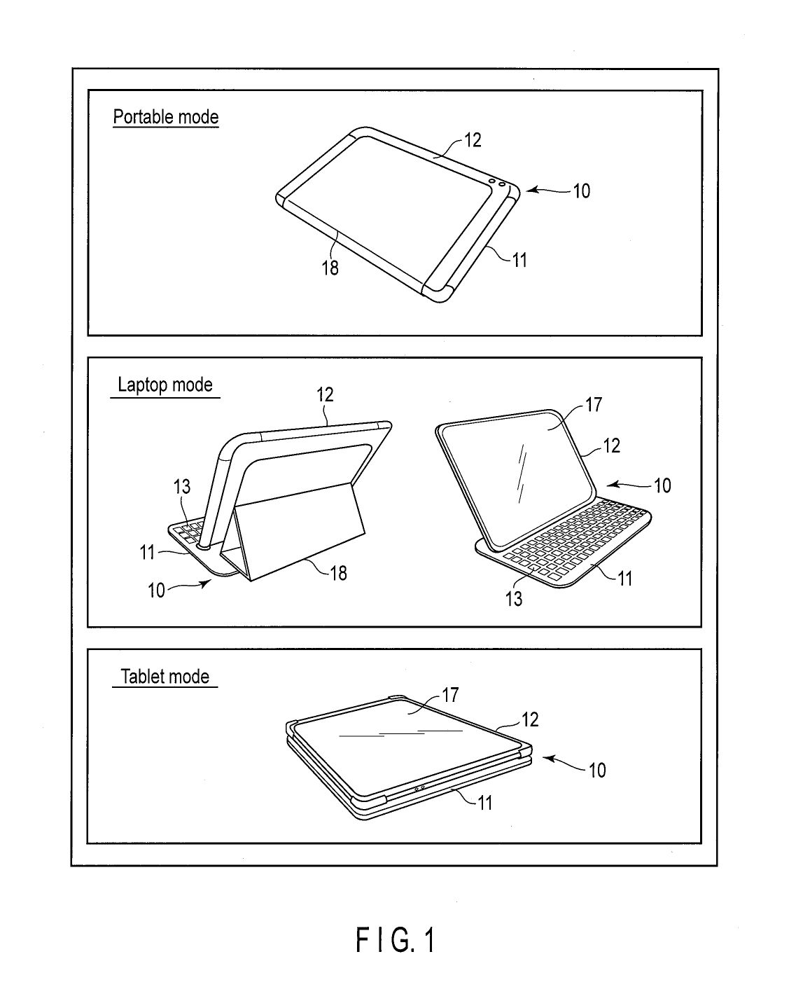

FIG. 1 illustrates external appearances of an electronic apparatus according to an embodiment, the external appearances corresponding to three modes (styles), namely a portable mode, a laptop mode and a tablet mode. The electronic apparatus is realized as, for example, a convertible computer 10. The convertible computer 10 is used in a style corresponding to any one of a portable mode illustrated in an upper part of FIG. 1, a laptop mode illustrated in a middle part of FIG. 1, and a tablet mode illustrated in a lower part of FIG. 1.

The convertible computer 10 includes a base unit 11, a display unit 12 and a hinge member 18. The base unit 11 includes a thin rectangular housing (first housing) which accommodates a communication module, a sensor, and other various electronic components. A keyboard 13 is disposed on a top surface of the base unit 11.

The display unit 12 includes a thin rectangular housing (second housing) which accommodates a processor, a memory, and other various electronic components. In the display unit 12, a display surface (screen) of a display 17 is disposed to be located on the front surface of the display unit 12. The display 17 is realized by a touch-screen display which can detect a position of a pen or a finger on the screen of the display 17.

The display unit 12 is set in any one of a first position a second position and third position. The first position corresponds to the style of the portable mode illustrated in the upper part of FIG. 1. The second position corresponds to the style of the laptop mode illustrated in the middle part of FIG. 1. The third position corresponds to the style of the tablet mode illustrated in the lower part of FIG. 1. To be more specific, the display unit 12 (second housing) is set in any one of the first position (portable mode) where the screen of the display 17 is not exposed and the entire top surface of the base unit 11 (first housing) is covered with the screen of the display 17, the second position (laptop mode) where the screen of the display 17 and the top surface of the base unit 11 are exposed, and the third position (tablet mode) where the screen of the display 17 is exposed and at least a part of the top surface of the base unit 11 is covered with the back surface of the display unit 12.

In addition, an upper end portion of the hinge member 18 is attached to the display unit 12, and a lower end portion of the hinge member 18 is attached to the base unit 11. In other words, the base unit 11 and display unit 12 are coupled via the hinge member 18. An easily deformable material, such as cloth or rubber, is used for the hinge member 18, and a part of the hinge member 18 includes a core material, such as an iron plate, for supporting the back surface of the display unit 12 at a time of the laptop mode.

The user can change the position of the display unit 12 (i.e. the arrangement between the base unit 11 and display unit 12) so that the mode of the convertible computer 10 may be changed from one of the portable mode, laptop mode and tablet mode to another of these modes.

The portable mode is used, for example, when the convertible computer 10 is not used, or when the convertible computer 10 is carried. In the portable mode, since neither the touch-screen display 17 nor the hardware keyboard 13 is exposed, the user does not perform an operation using the touch-screen display 17 or hardware keyboard 13.

In the laptop mode, the convertible computer 10 is used in a state in which the convertible computer 10 is placed on a horizontal plane, such as on the desk. As in the case of an ordinary laptop (notebook) computer, the user performs an operation using the hardware keyboard 13 or touch-screen display 17.

In the tablet mode, the convertible computer 10 is used in a state in which the user holds the convertible computer 10 by one hand or both hands, or in a state in which the convertible computer 10 is placed on a horizontal plane, such as on the desk. For example, the user holds the convertible computer 10 by the left hand and performs a touch operation on the screen of the display 17 by the right hand. To be more specific, the user, for example, holds the convertible computer 10 by the left hand, and performs an operation by the right hand on various graphical user interfaces (GUIs) such as a software keyboard displayed on the screen of the display 17.

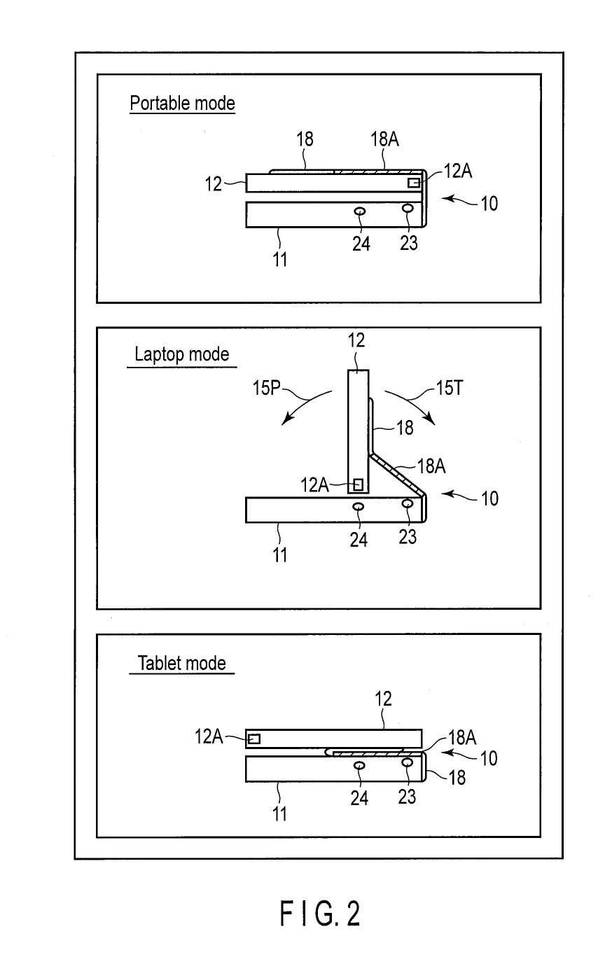

Referring now to FIG. 2, a description is given of the relationship between the base unit 11 and display unit 12 in each of the modes.

In the portable mode, for example, almost the entirety of the back surface of the display unit 12 is covered with the hinge member 18. Similarly, in the portable mode, the hinge member 18 may be provided in a manner to cover the back surface of the base unit 11. Specifically, in the portable mode, the hinge member 18 is used as a cover for protecting the back surface of the display unit 11 and the back surface of the base unit 11.

In the laptop mode, a core material 18A, such as an iron plate, which is provided in the hinge member 18, is used as a support member for supporting the back surface of the display unit 12, in order to make the display unit 12 stand up on the base unit 11.

Besides, in the tablet mode, the hinge member 18 is folded in two and sandwiched between the back surface of the display unit 12 and the top surface of the base unit 11.

As shown in FIG. 2, in order to detect the mode of the computer 10, a magnet 12A is embedded in the display unit 12, and a first magnetic sensor 23 and a second magnetic sensor 24 are embedded in the base unit 11. The magnet 12A is disposed in the display unit 12, for example, at such a position as to be able to approach the base unit 11. In addition, for example, the first magnetic sensor 23 is disposed at such a position (fourth position) as to be able to detect proximity of the magnet 12A at the time of the portable mode. The second magnetic sensor 24 is disposed at such a position (fifth position) as to be able to detect proximity of the magnet 12A at the time of the laptop mode.

The mode of the computer 10 is determined based on whether the magnet 12A is in proximity to each of the first magnetic sensor 23 and second magnetic sensor 24. That is, the mode of the computer 10 is determined based on whether a magnetic force of a threshold or more (e.g. an intensity of a magnetic field of a threshold or more, or a magnetic flux density of a threshold or more) has been detected by each of the first magnetic sensor 23 and second magnetic sensor 24.

In the portable mode illustrated in the upper part of FIG. 2, the first magnetic sensor 23 detects proximity of the magnet 12A (i.e. a magnetic force of the threshold or more), and the second magnetic sensor 24 detects non-proximity of the magnet 12A (i.e. a magnetic force of less than the threshold). In accordance with this detection, it is determined that the computer 10 is in the portable mode (first position) where the entire top surface of the base unit 11 is covered with the screen of the display unit 12.

In the laptop mode illustrated in the middle part of FIG. 2, the second magnetic sensor 24 detects proximity of the magnet 12A (i.e. a magnetic force of the threshold or more), and the first magnetic sensor 23 detects non-proximity of the magnet 12A (i.e. a magnetic force of less than the threshold). In accordance with this detection, it is determined that the computer 10 is in the laptop mode (second position) where the screen of the display 17 and the top surface of the base unit 11 are exposed. In the meantime, a groove (guide rail) may be provided at an area of the top surface of the base unit 11, with which a lower side surface of the display unit 12 comes in contact in the laptop mode. In addition, by disposing a magnetic body in at least a part of the area corresponding to this groove, such a configuration may be adopted that the lower side surface (magnet 12A) of the display unit 12 is magnetically attracted to the top surface (magnetic body) of the base unit 11. Thereby, the arrangement between the display unit 12 and base unit 11 in the laptop mode can be made stabler.

In the tablet mode illustrated in the lower part of FIG. 2, the first magnetic sensor 23 detects non-proximity of the magnet 12A (i.e. a magnetic force of less than the threshold), and the second magnetic sensor 24 detects non-proximity of the magnet 12A (i.e. a magnetic force of less than the threshold). In accordance with this detection, it is determined that the computer 10 is in the tablet mode (third position) where the screen of the display 17 is exposed and the entire top surface of the base unit 11 is covered with the back surface of the display unit 12.

For example, in the laptop mode illustrated in the middle part of FIG. 2, the user turns down the display unit 12 in a direction of an arrow 15P, and places the screen on the front surface of the display unit 12 over the top surface of the base unit 11. Thereby, the computer 10 transitions from the laptop mode to the portable mode. In addition, the user turns down the display unit 12 in a direction of an arrow 15T, and places the back surface of the display unit 12 over the top surface of the base unit 11. Thereby, the computer 10 transitions from the laptop mode to the tablet mode. In a similar manner, the user can change the mode of the computer 10.

As has been described above, an easily deformable material, such as cloth or rubber, is used for the hinge member 18. Thus, at a time of each mode, in some cases, there may occur a displacement in arrangement between the base unit 11 and display unit 12, or bending of the housing of each unit. Due to such a displacement in arrangement or bending of the housing, it is possible that a key on the hardware keyboard 13 or a key on a software keyboard 34c is pressed and a key input, which is not intended by the user, is executed. Furthermore, even while the arrangement between the base unit 11 and display unit 12 is being altered in order to change the mode, it is possible that a key on the hardware keyboard 13 or a key on the software keyboard 34c is pressed and a key input, which is not intended by the user, is executed.

Taking the above into account, in the embodiment, the “enable” or “disable” of the hardware keyboard 13 and software keyboard 34c is controlled in accordance with the mode in which the convertible computer 10 is set. Thereby, in the convertible computer 10, a key input, which is not intended by the user, can be suppressed.

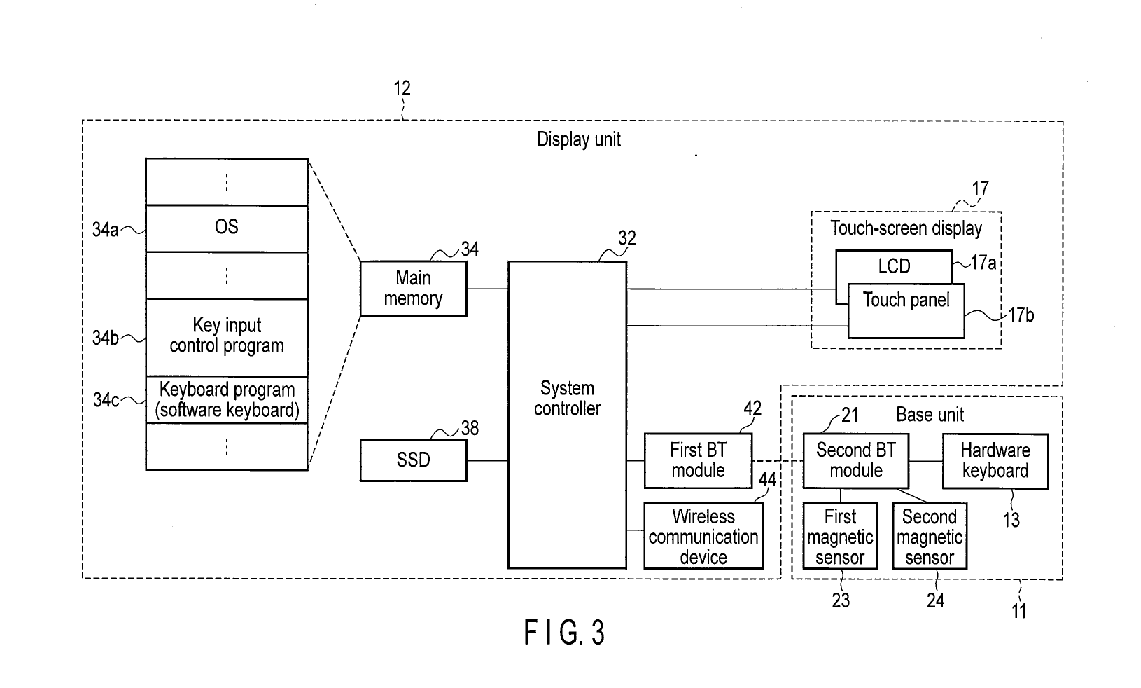

FIG. 3 illustrates a system configuration of the computer 10.

The computer 10, as shown in FIG. 3, includes a system controller 32, a main memory 34, a solid state drive (SSD) 38, a first BT (Bluetooth®) module 42, and a wireless communication device 44 in the display unit 12, and includes a second BT module 21, a first magnetic sensor 23, a second magnetic sensor 24, and a hardware keyboard 13 in the base unit 11.

The system controller 32 includes a function of a processor which controls operations of various modules implemented in the computer 10. The system controller 32 executes various kinds of software, which are loaded from the SSD 38 into the main memory 34. The SSD 38 is a nonvolatile storage device. The software includes an operating system (OS) 34a, a key input control program 34b, and a keyboard program (software keyboard) 34c.

The key input control program 34b includes a function of controlling the “enable” and “disable” of the software keyboard 34c in accordance with the mode of the convertible computer 10. The keyboard program 34c includes a software keyboard function of displaying an image of a keyboard on the screen and issuing a key code corresponding to a key on the image, in response to an operation (tap, touch, click, etc.) of pressing the key.

In addition, the system controller 32 executes a basic input/output system (BIOS). The BIOS is a program for hardware control.

The system controller 32 includes a memory controller which access-controls the main memory 34. The SSD 38, first BT module 42 and wireless communication device 44, as well as the main memory 34, are connected to the system controller 32.

The system controller 32 controls an LCD 17a which is used as a display monitor of the computer 10. The system controller 32 sends a display signal to the LCD 17a. The LCD 17a displays a screen image based on the display signal. A touch panel 17b is disposed on the display surface of the LCD 17a. The touch panel 17b is, for instance, an electrostatic-capacitance type sensor for executing an input on the screen of the LCD 17a.

The system controller 32 also includes a function of a controller for power management. The system controller 32 includes a function of powering on or powering off the computer 10 in accordance with an operation of a power button by the user.

The wireless communication device 44 is a device configured to execute wireless communication such as wireless LAN or 3G mobile communication.

The first BT module 42 provided in the display unit 12 and the second BT module 21 provided in the base unit 11 are modules configured to execute Bluetooth communication. The first BT module 42 and the second BT module 21 may be configured to execute not only Bluetooth communication, but also various close proximity wireless communications such as near field communication (NFC). The first BT module 42 and the second BT module 21 establish a Bluetooth connection, for example, when the computer 10 is booted.

The hardware keyboard 13, first magnetic sensor 23 and second magnetic sensor 24 are connected to the second BT module 21 provided in the base unit 11. The hardware keyboard 13 outputs to the second BT module 21 a key code corresponding to a pressed key of a plurality of keys provided on the keyboard 13. The first magnetic sensor 23 and second magnetic sensor 24 are used in order to determine the mode of the computer 10, as described above.

The second BT module 21 includes a processor. The processor determines the mode of the computer 10, based on outputs from the first magnetic sensor 23 and second magnetic sensor 24, and determines, based on a result of this determination, whether a key code which is output from the hardware keyboard 13 is to be output (transmitted) to the first BT module 42 (display unit 12). Based on the detection results by the first magnetic sensor 23 and second magnetic sensor 24, the second BT module 21 detects the set position of the display unit 12 (second housing) and then notifies the first BT module 42 (display unit 12) of the set position of the display unit 12.

For example, when the display unit 12 is set in the tablet mode (third position), the second BT module 21 disables an operation on the hardware keyboard 13. When the display unit 12 is set in the laptop mode (second position), the second BT module 21 enables an operation on the hardware keyboard 13. In addition, when the display unit 12 is set in the portable mode (first position), the second BT module 21 disables an operation on the hardware keyboard 13.

To be more specific, the second BT module 21 determines the mode of the computer 10, according to whether proximity of the magnet 12A in the display unit 12 is detected by either the first magnetic sensor 23 or second magnetic sensor 24 in the base unit 11, or according to whether proximity of the magnet 12A is detected by neither the first magnetic sensor 23 nor second magnetic sensor 24. When the first magnetic sensor 23 does not detect the magnet 12A and the second magnetic sensor 24 detects the magnet 12A, the second BT module 21 determines that the computer 10 is in the laptop mode. In addition, when the first magnetic sensor 23 does not detect the magnet 12A and the second magnetic sensor 24 does not detect the magnet 12A, the second BT module 21 determines that the computer 10 is in the tablet mode. When the first magnetic sensor 23 detects the magnet 12A and the second magnetic sensor 24 does not detect the magnet 12A, the second BT module 21 determines that the computer 10 is in the portable mode.

When the determined mode of the computer 10 is the laptop mode, the second BT module 21 sets the hardware keyboard 13 to be enable. Specifically, when the determined mode of the computer 10 is the laptop mode, the second BT module 21 executes such setting that a key code, which has been output from the hardware keyboard 13, is output (transmitted) to the first BT module 42 (display unit 12).

When the determined mode of the computer 10 is the tablet mode or portable mode, the second BT module 21 sets the hardware keyboard 13 to be disable. Specifically, when the determined mode of the computer 10 is the tablet more or portable mode, the second BT module 21 executes such setting that a key code, which has been output from the hardware keyboard 13, is not output (transmitted) to the first BT module 42 (display unit 12) (i.e. a key code is discarded).

The second BT module 21 transmits a key code, which is indicative of the determined mode of the computer 10, to the first BT module 42. When the determined mode of the computer 10 is the laptop mode, the second BT module 21 transmits a key code “BT Attach” to the first BT module 42. When the determined mode of the computer 10 is the tablet mode, the second BT module 21 transmits a key code “BT Detach” to the first BT module 42. When the determined mode of the computer 10 is the portable mode, the second BT module 21 transmits a key code “BT Lock” (or key codes “BT Detach” and “BT Lock”) to the first BT module 42.

The first BT module 42 receives the key code transmitted from the second BT module 21, and then outputs the key code to the system controller 32. The OS 34a or application program executed on the system controller 32 executes a process corresponding to this key code.

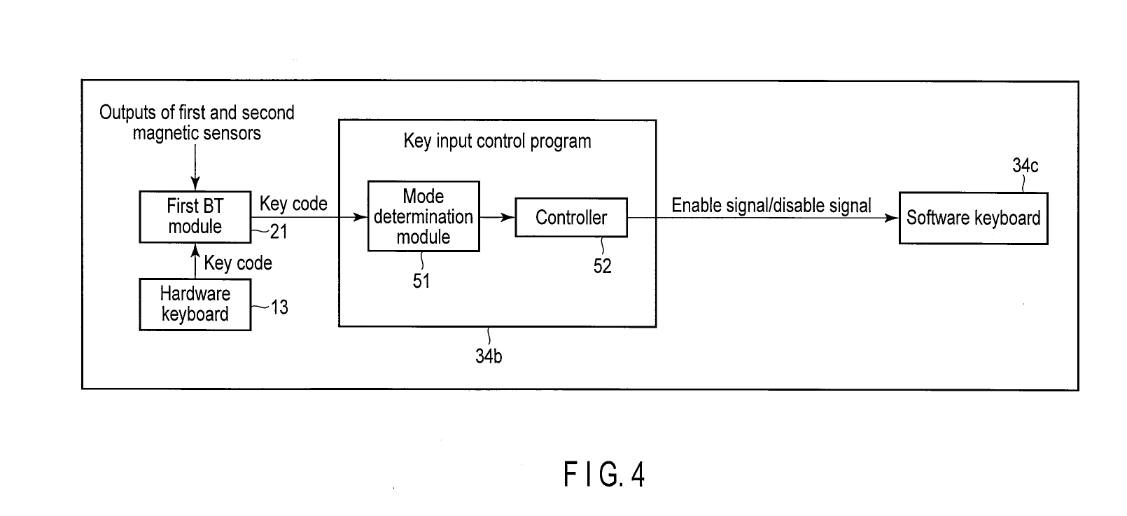

As illustrated in FIG. 4, the key input control program 34b, which is executed by the convertible computer 10 (system controller 32) includes a function of controlling the enable or disable of the software keyboard 34c in accordance with the mode of the convertible computer 10. The key input control program 34b controls the enable or disable of the software keyboard 34c, based on a specific key code which has been transmitted from the second BT module 21 (base unit 11). The key input control program 34b includes, for example, a mode determination module 51 and a controller 52.

When the computer 10 has been set in the tablet mode (third position) based on the specific key code transmitted from the second BT module 21, the mode determination module 51 and controller 52 enable an operation on the software keyboard 34b displayed on the screen. When the computer 10 has been set in the laptop mode (second position) based on the specific key code, the mode determination module 51 and controller 52 disable an operation on the software keyboard 34b displayed on the screen. When the computer has been set in the portable mode (first position), the mode determination module 51 and controller 52 set the system (OS 34a) in a suspend mode.

To be more specific, the mode determination module 51 receives a key code which has been transmitted from the second BT module 21. When the mode determination module 51 has received the key code “KB Attach”, the mode determination module 51 determines that the computer 10 is in the laptop mode. Then, the mode determination module 51 notifies the controller 52 that the computer 10 is in the laptop mode.

In response to the notification that the computer 10 is in the laptop mode, the controller 52 disables the software keyboard 34c. For example, the controller 52 hides the screen (image) of the software keyboard 34c being displayed on the screen of the LCD 17a.

When the mode determination module 51 has received the key code “KB Detach”, the mode determination module 51 determines that the computer 10 is in the tablet mode. Then, the mode determination module 51 notifies the controller 52 that the computer 10 is in the tablet mode.

In response to the notification that the computer 10 is in the tablet mode, the controller 52 enables the software keyboard 34c. For example, the controller 52 causes the screen (image) of the software keyboard 34c to be displayed on the screen of the LCD 17a.

When the mode determination module 51 has received the key code “KB Lock”, the mode determination module 51 determines that the computer 10 is in the portable mode. Then, the mode determination module 51 notifies the controller 52 that the computer 10 is in the portable mode.

In response to the notification that the computer 10 is in the portable mode, the controller 52 sets the system (OS 34a) in the suspend mode. Accordingly, as a matter of course, the software keyboard 34c is made unusable.

In the meantime, in response to the passing of a threshold time (e.g. 10 minutes) of time-out, the controller 52 may disconnect the connection between the first BT module 42 and second BT module 21. Thereby, the power consumption for the Bluetooth connection can be reduced.

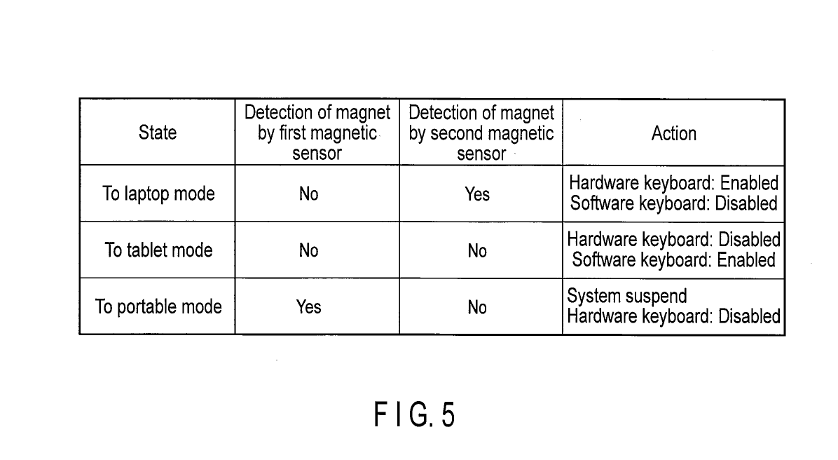

FIG. 5 shows a relationship between the determination of modes based on outputs of the magnetic sensors 23 and 24 and the enable/disable control of the hardware keyboard 13 and software keyboard 34c corresponding to the respective modes.

As shown in FIG. 5, when the first magnetic sensor 23 does not detect the magnet 12A (No) and the second magnetic sensor 24 detects the magnet 12A (Yes), it is determined that the computer 10 is in the laptop mode. In the laptop mode, the hardware keyboard 13 is enabled and the software keyboard 34c is disabled.

When the first magnetic sensor 23 does not detect the magnet 12A (No) and the second magnetic sensor 24 does not detect the magnet 12A (No), it is determined that the computer 10 is in the tablet mode. In the tablet mode, the hardware keyboard 13 is disabled and the software keyboard 34c is enabled.

When the first magnetic sensor 23 detects the magnet 12A (Yes) and the second magnetic sensor 24 does not detect the magnet 12A (No), it is determined that the computer 10 is in the portable mode. In the portable mode, the system is set in the suspend mode, and the hardware keyboard 13 is disabled. Thereby, in the portable mode, even a key for setting the system in a boot state, such as a “Dock” key, can be rendered inoperable on the computer 10.

In the meantime, while the arrangement between the base unit 11 and display unit 12 is being altered, it is assumed that the base unit 11 and display unit 12 do not come in contact. In this case, the first magnetic sensor 23 does not detect the magnet 12A (No) and the second magnetic sensor 24 does not detect the magnet 12A (No). Thus, like the tablet mode (i.e. the computer 10 is regarded as being in the tablet mode), the hardware keyboard 13 is disabled and the software keyboard 34c is enabled.

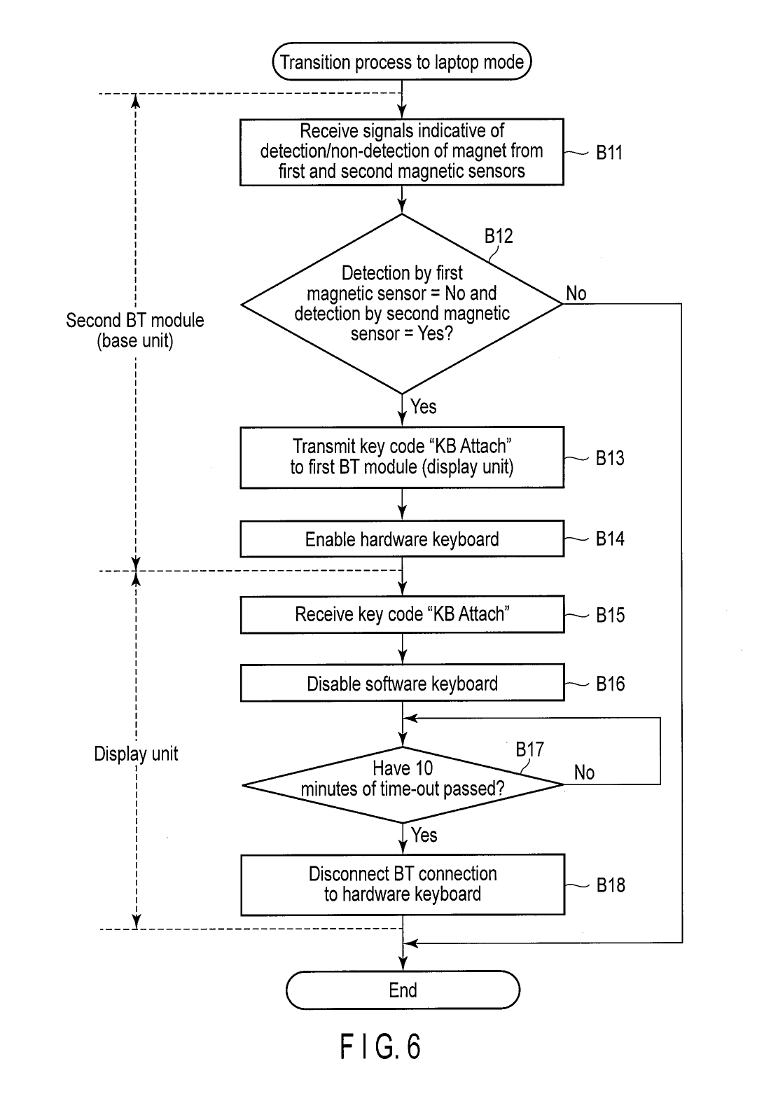

Next, referring to a flowchart of FIG. 6, a description is given of an example of the procedure of a transition process to the laptop mode.

To start with, the second BT module 21 provided in the base unit 11 receives signals indicative of detection/non-detection of the magnet 12A from the first magnetic sensor 23 and second magnetic sensor 24 (block B11). The second BT module 21 determines whether the signal received from the first magnetic sensor 23 is indicative of non-detection of the magnet 12A and the signal received from the second magnetic sensor 24 is indicative of detection of the magnet 12A (block B12). When the signal received from the first magnetic sensor 23 is indicative of detection of the magnet 12A or when the signal received from the second magnetic sensor 24 is indicative of non-detection of the magnet 12A (No in block B12), the process is terminated.

When the signal received from the first magnetic sensor 23 indicates non-detection of the magnet 12A and the signal received from the second magnetic sensor 24 indicates detection of the magnet 12A (Yes in block B12), the second BT module 21 transmits a key code “KB Attach” to the first BT module 42 (display unit 12) (block B13). The “KB Attach” indicates that the display unit 12 and base unit 11 are disposed in the laptop mode. Then, the second BT module 21 enables the hardware keyboard 13 (block B14). Specifically, the second BT module 21 executes such setting that a key code, which has been output from the hardware keyboard 13, is transmitted to the first BT module 42 (display unit 12).

Then, the mode determination module 51, which is provided in the key input control program 34b, receives the key code “KB Attach” which has been transmitted from the second BT module 21 (block B15). Upon receiving the key code “KB Attach”, the mode determination module 51 determines that the computer 10 is in the laptop mode. Then, responding to the determination that the computer 10 is in the laptop mode, the controller 52 disables the software keyboard 34c (block B16). Specifically, the controller 52 prohibits the screen (image) of the software keyboard 34c from being displayed on the screen of the LCD 17a.

Subsequently, the controller 52 determines whether a threshold time (e.g. 10 minutes) of time-out has passed or not (block B17). When the threshold time of time-out has not passed (No in block B17), the process returns to block B17. When the threshold time of time-out has passed (Yes in block B17), the controller 52 disconnects the Bluetooth connection to the hardware keyboard 13 (second BT module 21) via the first BT module 42 (block B18).

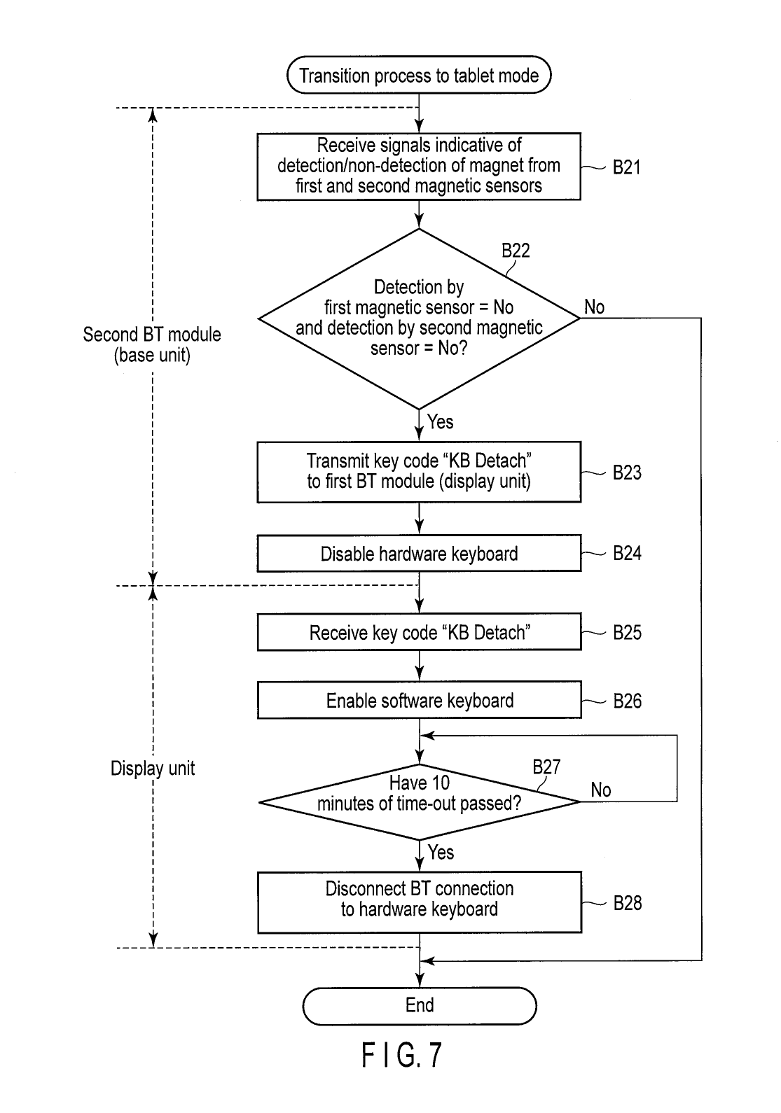

Next, referring to a flowchart of FIG. 7, a description is given of an example of the procedure of a transition process to the tablet mode.

To start with, the second BT module 21 provided in the base unit 11 receives signals indicative of detection/non-detection of the magnet 12A from the first magnetic sensor 23 and second magnetic sensor 24 (block B21). The second BT module 21 determines whether the signal received from the first magnetic sensor 23 is indicative of non-detection of the magnet 12A and the signal received from the second magnetic sensor 24 is indicative of non-detection of the magnet 12A (block B22). When the signal received from the first magnetic sensor 23 is indicative of detection of the magnet 12A or when the signal received from the second magnetic sensor 24 is indicative of detection of the magnet 12A (No in block B22), the process is terminated.

When the signal received from the first magnetic sensor 23 indicates non-detection of the magnet 12A and the signal received from the second magnetic sensor 24 indicates non-detection of the magnet 12A (Yes in block B22), the second BT module 21 transmits a key code “KB Detach” to the first BT module 42 (display unit 12) (block B23). The “KB Detach” indicates that the display unit 12 and base unit 11 are disposed in the tablet mode. Then, the second BT module 21 disables the hardware keyboard 13 (block B24). Specifically, the second BT module 21 executes such setting that a key code, which has been output from the hardware keyboard 13, is not transmitted to the first BT module 42 (display unit 12).

Then, the mode determination module 51, which is provided in the key input control program 34b, receives the key code “KB Detach” which has been transmitted from the second BT module 21 (block B25). Upon receiving the key code “KB Detach”, the mode determination module 51 determines that the computer 10 is in the tablet mode. Then, responding to the determination that the computer 10 is in the tablet mode, the controller 52 enables the software keyboard 34c (block B26). Specifically, the controller 52 causes the screen (image) of the software keyboard 34c to be displayed on the screen of the LCD 17a.

Subsequently, the controller 52 determines whether a threshold time (e.g. 10 minutes) of time-out has passed or not (block B27). When the threshold time of time-out has not passed (No in block B27), the process returns to block B27. When the threshold time of time-out has passed (Yes in block B27), the controller 52 disconnects the Bluetooth connection to the hardware keyboard 13 (second BT module 21) via the first BT module 42 (block B28).

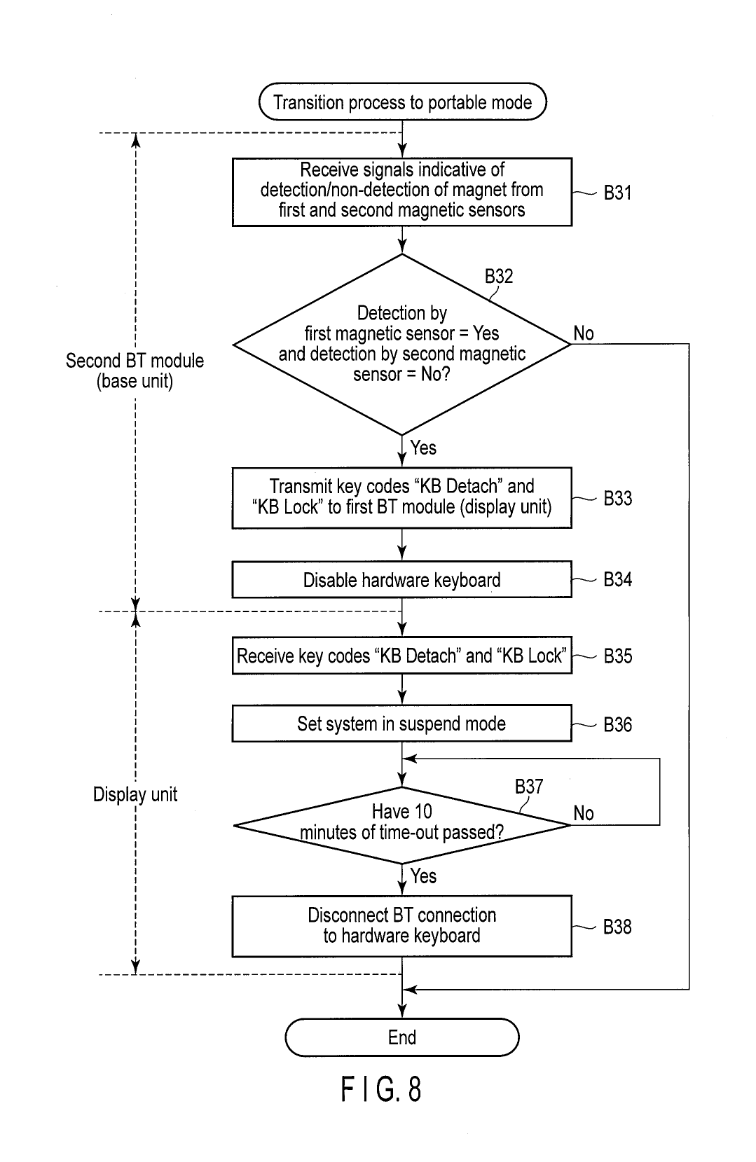

Next, referring to a flowchart of FIG. 8, a description is given of an example of the procedure of a transition process to the portable mode.

To start with, the second BT module 21 provided in the base unit 11 receives signals indicative of detection/non-detection of the magnet 12A from the first magnetic sensor 23 and second magnetic sensor 24 (block B31). The second BT module 21 determines whether the signal received from the first magnetic sensor 23 is indicative of detection of the magnet 12A and the signal received from the second magnetic sensor 24 is indicative of non-detection of the magnet 12A (block B32). When the signal received from the first magnetic sensor 23 is indicative of non-detection of the magnet 12A or when the signal received from the second magnetic sensor 24 is indicative of detection of the magnet 12A (No in block B32), the process is terminated.

When the signal received from the first magnetic sensor 23 indicates detection of the magnet 12A and the signal received from the second magnetic sensor 24 indicates non-detection of the magnet 12A (Yes in block B32), the second BT module 21 transmits key codes “KB Detach” and “KB Lock” to the first BT module 42 (display unit 12) (block B33). The “KB Lock” indicates that the display unit 12 and base unit 11 are disposed in the portable mode. Then, the second BT module 21 disables the hardware keyboard 13 (block B34). Specifically, the second BT module 21 executes such setting that a key code, which has been output from the hardware keyboard 13, is not transmitted to the first BT module 42 (display unit 12).

Then, the mode determination module 51, which is provided in the key input control program 34b, receives the key codes “KB Detach” and “KB Lock” which have been transmitted from the second BT module 21 (block B35). Upon receiving the key code “KB Lock”, the mode determination module 51 determines that the computer 10 is in the portable mode. Then, responding to the determination that the computer 10 is in the portable mode, the controller 52 sets the system (OS 34a) in the suspend mode (block B36). Accordingly, as a matter of course, the software keyboard 34c is rendered unusable.

Subsequently, the controller 52 determines whether a threshold time (e.g. 10 minutes) of time-out has passed or not (block B37). When the threshold time of time-out has not passed (No in block B37), the process returns to block B37. When the threshold time of time-out has passed (Yes in block B37), the controller 52 disconnects the Bluetooth connection to the hardware keyboard 13 (second BT module 21) via the first BT module 42 (block B38).

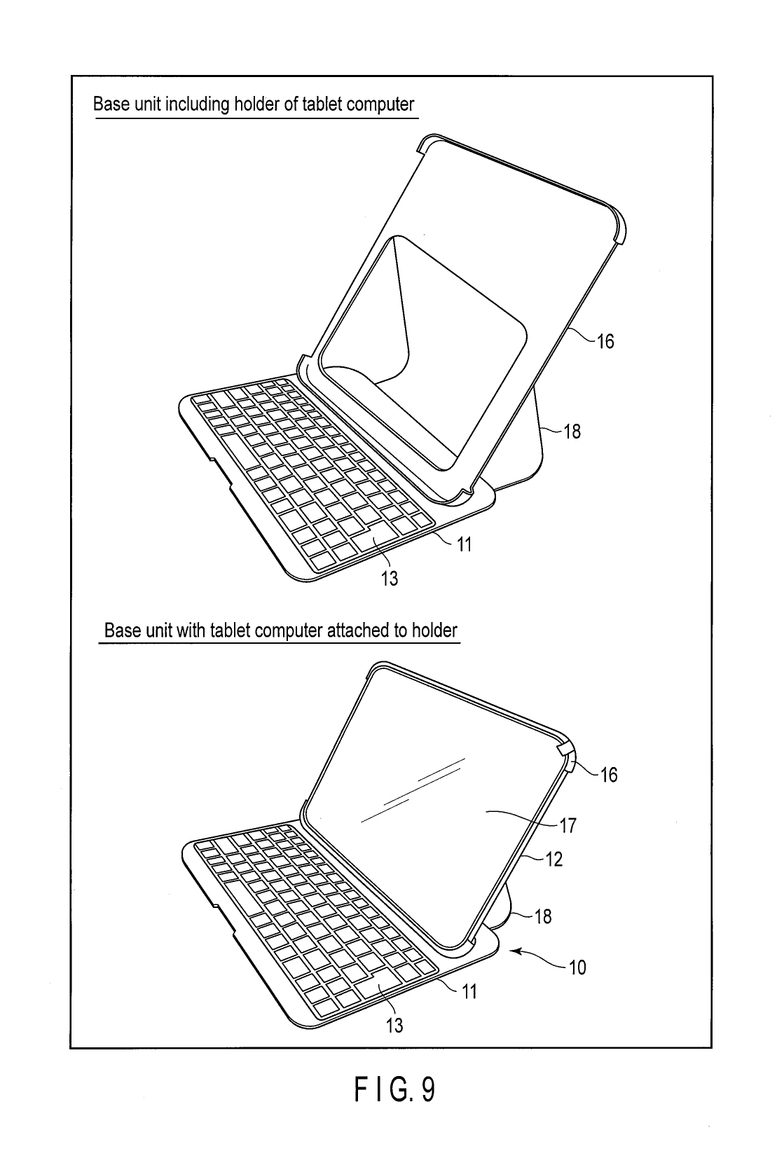

Next, referring to FIG. 9, another example of the structure of the convertible computer 10 of the embodiment is described. The convertible computer 10 includes a base unit 11 including a holder 16 of the display unit 12 (e.g. a tablet computer), which is shown in an upper part of FIG. 9, and a display unit 12. As shown in a lower part of FIG. 9, the display unit 12 is attached to the holder 16 provided on the base unit 11. Thereby, a computer similar to the convertible computer 10 as shown in FIG. 1 can be realized. Specifically, the convertible computer 10 is realized by attaching a tablet computer, which is used as the display unit 12, to the holder 16 of the base unit 11 including a hardware keyboard 13. Thereby, the convertible computer 10 can be used in a style corresponding to any one of the portable mode, laptop mode and tablet mode.

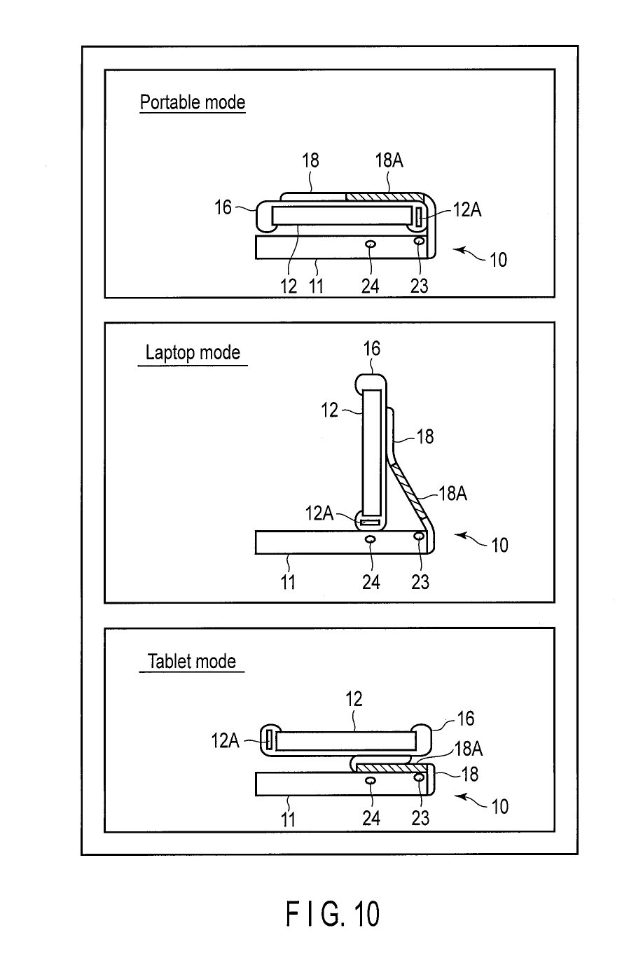

As illustrated in FIG. 10, in the portable mode, for example, almost the entirety of the back surface of the holder 16, to which the display unit 12 is attached, is covered with the hinge member 18. Similarly, in the portable mode, the hinge member 18 may be provided in a manner to cover the back surface of the base unit 11. Specifically, in the portable mode, the hinge member 18 is used as a cover for protecting the back surface of the holder 16 and the back surface of the base unit 11.

In the laptop mode, a core material 18A, such as an iron plate, which is provided in the hinge member 18, is used as a support member for supporting the back surface of the holder 16, in order to make the holder 16, to which the display unit 12 is attached, stand up on the base unit 11.

Besides, in the tablet mode, the hinge member 18 is folded in two and sandwiched between the back surface of the holder 16, to which the display unit 12 is attached, and the top surface of the base unit 11.

As shown in FIG. 10, in order to detect the mode of the computer 10, a magnet 12A is embedded in the holder 16, and a first magnetic sensor 23 and a second magnetic sensor 24 are embedded in the base unit 11. The mode of the computer 10 is determined, based on whether the magnet 12A is in proximity to each of the first magnetic sensor 23 and second magnetic sensor 24, that is, whether a magnetic force of a threshold or more (e.g. an intensity of a magnetic field of a threshold or more, or a magnetic flux density of a threshold or more) has been detected by each of the first magnetic sensor 23 and second magnetic sensor 24.

In the portable mode illustrated in the upper part of FIG. 10, the first magnetic sensor 23 detects proximity of the magnet 12A (i.e. a magnetic force of the threshold or more), and the second magnetic sensor 24 detects non-proximity of the magnet 12A (i.e. a magnetic force of less than the threshold). In accordance with this detection, it is determined that the computer 10 is in the portable mode (first position) where the entire top surface of the base unit 11 is covered with the screen of the display unit 12.

In the laptop mode illustrated in the middle part of FIG. 10, the second magnetic sensor 24 detects proximity of the magnet 12A (i.e. a magnetic force of the threshold or more), and the first magnetic sensor 23 detects non-proximity of the magnet 12A (i.e. a magnetic force of less than the threshold). In accordance with this detection, it is determined that the computer 10 is in the laptop mode (second position) where the screen of the display 17 and the top surface of the base unit 11 are exposed. In the meantime, a groove (guide rail) may be provided at an area of the top surface of the base unit 11, with which a lower side surface of the holder 16, to which the display unit 12 is attached, comes in contact in the laptop mode. In addition, by disposing a magnetic body in at least a part of the area corresponding to this groove, such a configuration may be adopted that the lower side surface (magnet 12A) of the holder 16 is magnetically attracted to the top surface (magnetic body) of the base unit 11. Thereby, the arrangement between the display unit 12 (i.e. the holder 16) and the base unit 11 in the laptop mode can be made stabler.

In the tablet mode illustrated in the lower part of FIG. 10, the first magnetic sensor 23 detects non-proximity of the magnet 12A (i.e. a magnetic force of less than the threshold), and the second magnetic sensor 24 detects non-proximity of the magnet 12A (i.e. a magnetic force of less than the threshold). In accordance with this detection, it is determined that the computer 10 is in the tablet mode (third position) where the screen of the display 17 is exposed and the entire top surface of the base unit 11 is covered with the back surface of the holder 16 to which the display unit 12 is attached.

As has been described above, the “enable” or “disable” of the hardware keyboard 13 and software keyboard 34c is controlled in accordance with the determination of the mode (position) of the computer 10. Thereby, an erroneous operation by the user on the convertible computer can be suppressed.

According to the embodiment, as described above, an erroneous operation by the user on the convertible computer can be suppressed. In the computer 10, the hardware keyboard 13 is disposed on the top surface of the base unit (first housing) 11, and the display 17 is disposed on the front surface of the display unit 12 (second housing). The display unit 12 (second housing) is set in either the second position (i.e. laptop mode) where the screen of the display 17 and the top surface of the base unit 11 are exposed, or the third position (i.e. the tablet mode) where the screen of the display 17 is exposed and at least a part of the top surface of the base unit 11 is covered with the back surface of the display unit 12. When the display unit 12 is set in the third position, the second BT module 21 disables an operation on the hardware keyboard 13. When the display unit 12 is set in the second position, the second BT module 21 enables an operation on the hardware keyboard 13. When the display unit 12 is set in the third position, the controller 52 provided in the key input control program 34b enables an operation on the software keyboard 34c displayed on the screen. When the display unit 12 is set in the second position, the controller 52 disables an operation on the software keyboard 34c displayed on the screen.

Thereby, when the computer 10 is in the laptop mode, the hardware keyboard 13 is enabled and the software keyboard 34c is disabled. When the computer 10 is in the tablet mode, the hardware keyboard 13 is disabled and the software keyboard 34c is enabled. Thus, an erroneous operation by the user on the computer 10 can be suppressed.

All the process procedures of the embodiment, which have been described with reference to the flowcharts of FIGS. 6 to 8, can be executed by software. Thus, the same advantageous effects as with the present embodiment can easily be obtained simply by installing a computer program, which executes the process procedures, into an ordinary computer through a computer-readable storage medium, which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first housing comprising a top surface on which a hardware keyboard is disposed;
a second housing comprising a front surface on which a display is disposed, the second housing being set in either a first position where a screen of the display and the top surface are exposed, or a second position where the screen of the display is exposed and at least a part of the top surface is covered with a back surface of the second housing;
a first controller configured to enable an operation on the hardware keyboard when the second housing is set in the first position, and to disable the operation on the hardware keyboard when the second housing is set in the second position; and
a second controller configured to disable an operation on a software keyboard displayed on the screen when the second housing is set in the first position, and to enable the operation on the software keyboard when the second housing is set in the second position.

2. The electronic apparatus of claim 1, wherein the second housing is set in one of the first position, the second position, and a third position where the top surface is covered with the screen of the display,
the first controller is configured to disable the operation on the hardware keyboard when the second housing is set in the third position, and
the second controller is configured to set a system in a suspend mode when the second housing is set in the third position.

3. The electronic apparatus of claim 1, further comprising:
a magnet disposed in the second housing at such a position as to be able to approach the first housing;
a first magnetic sensor disposed at a fourth position in the first housing, and configured to detect a magnetic force by the magnet; and
a second magnetic sensor disposed at a fifth position in the first housing, and configured to detect the magnetic force by the magnet,
wherein the first controller is configured to detect a set position of the second housing, based on detection results by the first magnetic sensor and the second magnetic sensor, and to notify the second controller of the set position of the second housing.

4. The electronic apparatus of claim 3, wherein the first controller is configured to detect that the second housing is in the first position when the first magnetic sensor does not detect the magnetic force by the magnet and the second magnetic sensor detects the magnetic force by the magnet, and to detect that the second housing is in the second position when both of the first magnetic sensor and the second magnetic sensor do not detect the magnetic force by the magnet.

5. The electronic apparatus of claim 4, wherein the second housing is set in one of the first position, the second position, and a third position where the top surface is covered with the screen of the display, and
the first controller is configured to detect that the second housing is in the third position when the first magnetic sensor detects the magnetic force by the magnet and the second magnetic sensor does not detect the magnetic force by the magnet.

6. The electronic apparatus of claim 1, wherein the first controller is configured not to output a key code output by the hardware keyboard, when the operation on the hardware keyboard is disabled.

7. The electronic apparatus of claim 1, wherein the second controller is configured not to display the software keyboard on the screen of the display, when the operation on the software keyboard is disabled.

8. An input control method of an electronic apparatus comprising a first housing comprising a top surface on which a hardware keyboard is disposed, and a second housing comprising a front surface on which a display is disposed, the second housing being set in either a first position where a screen of the display and the top surface are exposed, or a second position where the screen of the display is exposed and at least a part of the top surface is covered with a back surface of the second housing, the method comprising:
enabling an operation on the hardware keyboard when the second housing is set in the first position, and disabling the operation on the hardware keyboard when the second housing is set in the second position; and
disabling an operation on a software keyboard displayed on the screen when the second housing is set in the first position, and enabling the operation on the software keyboard when the second housing is set in the second position.

9. An electronic apparatus comprising:
a first housing comprising a top surface on which a hardware keyboard is disposed;
a second housing comprising a front surface on which a display is disposed, the second housing being set in either a first position where a screen of the display and the top surface are exposed, or a second position where the screen of the display is exposed and at least a part of the top surface is covered with a back surface of the second housing;
a magnet disposed in the second housing at such a position as to be able to approach the first housing;
a first magnetic sensor disposed at a third position in the first housing, and configured to detect a magnetic force by the magnet;
a second magnetic sensor disposed at a fourth position in the first housing, and configured to detect the magnetic force by the magnet; and
a detector configured to detect a set position of the second housing, based on detection results by the first magnetic sensor and the second magnetic sensor.

10. The electronic apparatus of claim 9, wherein the detector is configured to detect that the second housing is in the first position when the first magnetic sensor does not detect the magnetic force by the magnet and the second magnetic sensor detects the magnetic force by the magnet, and to detect that the second housing is in the second position when both of the first magnetic sensor and the second magnetic sensor do not detect the magnetic force by the magnet.

11. The electronic apparatus of claim 10, wherein the second housing is set in one of the first position, the second position, and a fifth position where the top surface is covered with the screen of the display, and
the detector is configured to detect that the second housing is in the fifth position when the first magnetic sensor detects the magnetic force by the magnet and the second magnetic sensor does not detect the magnetic force by the magnet.
